(19) United States
(12) Patent Application Publication
(10) Pub. No.: US 2013/0144812 A1
(43) Pub. Date: Jun. 6, 2013

(54) PROBABILISTIC MODEL APPROXIMATION FOR STATISTICAL RELATIONAL LEARNING

(71) Applicants: Arun Tejasvi Chaganty, Chennai (IN); Akash Lal, Bangalore (IN); Aditya V. Nori, Bangalore (IN); Sriram Rajamani, Bangalore (IN)

(72) Inventors: Arun Tejasvi Chaganty, Chennai (IN); Akash Lal, Bangalore (IN); Aditya V. Nori, Bangalore (IN); Sriram Rajamani, Bangalore (IN)

(73) Assignee: MICROSOFT CORPORATION, Redmond, WA (US)

(21) Appl. No.: 13/308,571

(22) Filed: Dec. 1, 2011

(51) Int. Cl. G06F 15/18

(52) U.S. Cl. 706/12

(57) ABSTRACT

Various technologies described herein pertain to approximating an inputted probabilistic model for statistical relational learning. An initial approximation of formulae included in an inputted probabilistic model can be formed, where the initial approximation of the formulae omits axioms included in the inputted probabilistic model. Further, an approximated probabilistic model of the inputted probabilistic model can be constructed, where the approximated probabilistic model includes the initial approximation of the formulae. Moreover, the approximated probabilistic model and evidence can be fed to a relational learning engine, and a most probable explanation (MPE) world can be received from the relational learning engine. The evidence can comprise existing valuations of a subset of relations included in the inputted probabilistic model. The MPE world can include valuations for the relations included in the inputted probabilistic model. The MPE world can be outputted when the input probabilistic model lacks an axiom violated by the MPE world.

### BACKGROUND

Statistical relational learning pertains to inferring new relations from an existing data corpus using probabilistic formulas as specifications. For instance, from a large database of relations, statistical relational learning can be employed to infer new relationships from existing relationships in the database. According to an example, in the context of university departments, data about papers co-authored by faculty and graduate students, courses taught, and teaching assistant data (e.g., which graduate students were teaching assistants for which faculty) can be included in a database. Following this example, it may be desirable to infer advisor-advisee relationships in the department. As another example, in the context of bibliographic data present on the Internet, different instances of bibliographic records may abbreviate author names, conference names and paper titles differently. In addition, there may be spelling errors and other variations in various words. In the presence of such variations, it may be desirable to infer which bibliographic records, papers, conference names, and author names are equivalent.

Such problems involve an interplay between logic and probability. Logic provides the tools to state intuitions about how new relationships can be derived from existing relationships. For example, the statement “if two papers have the same title and the same authors, then the two papers are the same” can be represented in logic using a formula F. Probability provides tools to deal with incompleteness of models, uncertainty, and errors in data. Weighted formulae combine both logic and probability. An example of a weighted formula is 0.7:F, where the weight 0.7 denotes a confidence in a world satisfying the formula F.

Recently, there has been research in combining logic and probabilistic reasoning, leading to development of statistical relational learning and its many applications. In statistical relational learning, probabilistic models are specified by Markov Logic Networks (MLNs), which specify relational worlds using a set of probabilistic first-order logical formulae. Formally, an MLN L is a triple L= [symbol] , [symbol] , [symbol] , where [symbol] is a set of domains, [symbol] is a set of relations over the domains, and [symbol] is a set of weighted first-order logic formulae. A world is a valuation to the relations in the set [symbol] . A world ω₁ that satisfies more formulae from [symbol] is more likely than a world ω₂ that satisfies less formulae from [symbol] . The formulae [symbol] implicitly define a probability distribution over the set of worlds. Input evidence is a valuation to some of the relations in [symbol] . Informally, the goal of statistical relational learning is to infer a most likely world given the evidence. Formally, the goal of statistical relational learning is to infer a world \hat{ω} which maximizes the probability of a suitably defined joint probability distribution, given the evidence.

In an MLN, formulae with weight 0 or 1 are called axioms. Formulae with weight 1 are tautologies not to be violated by an inferred world, and formulae with weight 0 are unsatisfiable statements not to be satisfied by an inferred world. A world ω satisfies an axiom 1:F if and only if F evaluates to true in the world ω. A world ω satisfies an axiom 0:F if and only if F evaluates to false in the world ω. An axiom oftentimes denotes a basic structure to be satisfied by an inferred world. According to an example, the basic structure to be satisfied can be to make a certain inferred relation an equivalence relation. Further, a formula included in the formulae [symbol] that is not an axiom is called a soft formula. A world ω that is inferred for an MLN L needs to necessarily satisfy all the axioms. However, soft formulae are optional and may or may not be satisfied by the world ω.

Inference over an MLN is commonly performed by grounding variables. The variables are grounded by expanding out and instantiating quantifiers, thus resulting in a grounded MLN. An inference algorithm can thereafter be used over the grounded MLN. Grounding, however, can impose a significant burden on the inference algorithm, thus making such inference prohibitively expensive, especially for large real-world applications.

For example, consider the MLN for removing duplicate entries in a citation database. The MLN can include formulae of the form:

$$∀ {b}_{0} {b}_{1} . \\ SameAuthor ( BibAuthor ( {b}_{0} ) , BibAuthor ( {b}_{1} ) ) ⋀ Same Title ( BibTitle ( {b}_{0} ) , BibTitle ( {b}_{1} ) ) ⇒ SameBib ( {b}_{0 ,} {b}_{1} ) \qquad ( 1 )$$

The foregoing exemplary formula states that if any two citations have the same authors and same title, then they are likely to be the same paper. Uncertainty in this rule can be modeled by attaching a weight to this rule. Moreover, the predicates SameAuthor, SameTitle, and SameBib can be encoding equivalences for authors, titles, and citations, respectively. Consequently, rules of equivalence are commonly added as axioms to give meaning to these predicates. For instance, with respect to the predicate SameBib, the following axioms oftentimes are added to a set of formulae of a probabilistic model.

$$\begin{matrix}Reflexivity \text{:} ∀ {b}_{0} . & SameBib ( {b}_{0 ,} {b}_{0} ) \\ Symmetry \text{:} ∀ {b}_{0} {b}_{1} . & SameBib ( {b}_{0 ,} {b}_{1} ) ⇒ SameBib ( {b}_{1 ,} {b}_{0} ) \\ Transitivity \text{:} ∀ {b}_{0} {b}_{1} {b}_{2} . & SameBib ( {b}_{0 ,} {b}_{1} ) ⋀ SameBib ( {b}_{1 ,} {b}_{0} ) \\ & ⇒ SameBib ( {b}_{0 ,} {b}_{2} )\end{matrix} \qquad ( 2 )$$

Moreover, functions such as BibAuthor and BibTitle can be specified as congruences with respect to the predicate SameBib. This can be done using the following axioms.

∀b₀b₁. SameBib(b₀,b₁) [symbol] SameAuthor(BidAuthor(b₀),BidAuthor(b₁))

∀b₀b₁. SameBib(b₀,b₁) [symbol] SameTitle(BidTitle(b₀),BidTitle(b₁)) (3)

However, additional formulae, such as the formulae described above, being included in a set of formulae of a probabilistic model can add more complexity to the probabilistic model. Further, the additional formulae can adversely affect the scalability of an inference algorithm used to evaluate the probabilistic model. Moreover, since variables in these formulae are usually universally quantified, current inference algorithms, as a part of their grounding phase, commonly eliminate these quantifiers by expanding them over constants in the dataset.

### SUMMARY

Described herein are various technologies that pertain to approximating an inputted probabilistic model for statistical relational learning. An initial approximation of formulae included in an inputted probabilistic model can be formed, where the initial approximation of the formulae omits axioms included in the inputted probabilistic model. Further, an approximated probabilistic model of the inputted probabilistic model can be constructed, where the approximated probabilistic model includes the initial approximation of the formulae. Moreover, the approximated probabilistic model and evidence can be inputted to a relational learning engine, and a most probable explanation (MPE) world can be received from the relational learning engine. The evidence can comprise existing valuations of a subset of relations included in the inputted probabilistic model. The MPE world can include valuations for the relations included in the inputted probabilistic model. The MPE world can be outputted when the inputted probabilistic model lacks an axiom violated by the MPE world.

According to various embodiments, one or more of the axioms included in the inputted probabilistic model can be iteratively added to subsequent approximated probabilistic models. For example, if the MPE world received from the relational learning engine violates at least one of the axioms of the input probabilistic model, then the approximated probabilistic model can be updated, the updated probabilistic model can be fed to the relational learning engine, an updated MPE world can be received from the relational learning engine, and so forth. Further, a set of conflict axioms violated by the MPE world can be formed. Pursuant to an example, the set of conflict axioms can be formed using database querying. Moreover, according to various embodiments, the set of conflict axioms can be generalized to reduce a number of iterations of approximating the inputted probabilistic model. In accordance with an example, the input probabilistic model can be a Markov Logic Network (MLN); yet, the claimed subject matter is not so limited.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that approximates a probabilistic model 102 for statistical relational learning.

FIG. 2 illustrates an exemplary Markov Logic Network (MLN).

FIG. 3 illustrates exemplary evidence and an exemplary query associated with the MLN of FIG. 2.

FIG. 4 illustrates a functional block diagram of an exemplary system that generalizes conflict axioms selected for inclusion in an approximation of a probabilistic model for statistical relational learning.

FIG. 5 is a flow diagram that illustrates an exemplary methodology for approximating an inputted probabilistic model for statistical relational learning.

FIG. 6 is a flow diagram that illustrates an exemplary methodology for iteratively approximating an inputted probabilistic model for statistical relational learning.

FIG. 7 is a flow diagram that illustrates an exemplary methodology for generalizing conflict axioms used for approximating an inputted probabilistic model.

FIG. 8 illustrates an exemplary computing device.

### DETAILED DESCRIPTION

Various technologies pertaining to iteratively approximating a probabilistic model for statistical relational learning are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, a probabilistic model can be approximated for statistical relational learning. The approximated probabilistic model can be used to infer valuations of relations from existing valuations of relations (e.g., evidence) in a database. An inputted probabilistic model can include a set of formulae, where the set of formulae include a set of axioms and a set of soft formulae. Axioms are probabilistic formulas with probability 0 or 1, which are required to be satisfied by inferred valuations to relations included in the inputted probabilistic model. Further, a valuation to the relations included in the inputted probabilistic model is referred to as a world. Axioms from the inputted probabilistic model can be lazily and iteratively added to the approximated probabilistic model of the inputted probabilistic model by applying a Counterexample Guided Abstraction Refinement (CEGAR) scheme. Moreover, the approximated probabilistic model can be inputted to a relational learning engine, which can infer valuations of relations based on the approximated probabilistic model. Further, convergence of the CEGAR scheme can be accelerated by generalizing axioms to be added to the approximated probabilistic model; such generalization can reduce a number of iterations of approximating the inputted probabilistic model. Moreover, a world inferred by a relational learning engine based on an approximated probabilistic model can be checked for consistency with axioms included in the inputted probabilistic model. The consistency checking, for example, can employ database querying techniques. Iterative approximation of the inputted probabilistic model as set forth herein can improve efficiency of solving statistical relational learning problems.

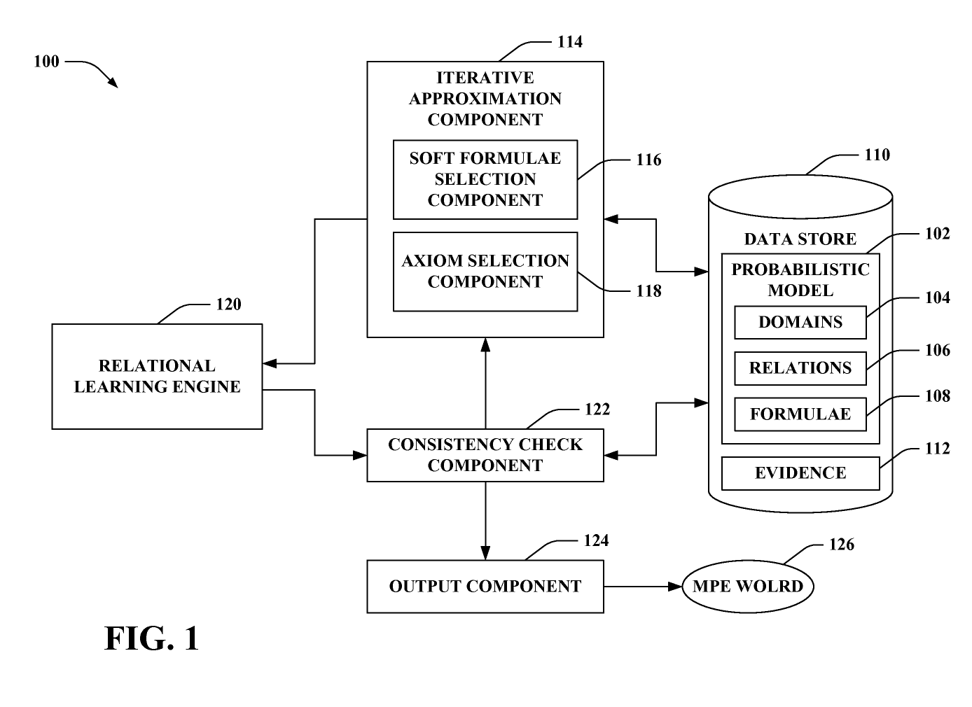

Referring now to the drawings, FIG. 1 illustrates a system 100 that approximates a probabilistic model 102 for statistical relational learning. The probabilistic model 102 includes domains 104, relations 106, and formulae 108. Moreover, the formulae 108 include axioms and soft formulae. According to an example, the probabilistic model 102 can be a Markov Logic Network (MLN); yet, it is contemplated that other probabilistic models are intended to fall within the scope of the hereto appended claims.

The probabilistic model 102, for instance, can be retained in a data store 110. Moreover, the data store 110 can include evidence 112. The evidence 112 is a corpus of data, which is an incomplete valuation of the relations 106 in the probabilistic model 102.

The system 100 can learn values of relations 106 from the corpus of data (e.g., the evidence 112) given weighted formulae 108 as specifications. The weight of a formula (e.g., from the formulae 108) is a real number in the interval [0, 1] that is used to model a confidence in the formula. Through relational learning, valuation of a remainder of the relations 106 (e.g., values of a subset of the relations 106 not included in the evidence 112) can be generated and a world can be inferred in order to satisfy the specifications in an optimum manner.

An iterative approximation component 114 can construct an approximated probabilistic model of the probabilistic model 102 (e.g., an inputted probabilistic model). The iterative approximation component 114 can include a soft formulae selection component 116 and an axiom selection component 118 that can form an approximation of the formulae 108 included in the probabilistic model 102. The approximated probabilistic model constructed by the iterative approximation component 114 can include the domains 104 from the probabilistic model 102, the relations 106 from the probabilistic model 102, and the approximation of the formulae 108 formed by the soft formulae selection component 116 and the axiom selection component 118.

The soft formulae selection component 116 can select the soft formulae from the formulae 108 included in the probabilistic model 102 for inclusion in approximations of the formulae 108. Moreover, the axiom selection component 118 can omit axioms from the formulae 108 included in the probabilistic model 102 from being included in an initial approximation of the formulae 108. Further, the axiom selection component 118 can iteratively add axiom(s) from the formulae 108 included in the probabilistic model 102 to subsequent approximations of the formulae 108 (e.g., approximations of the formulae 108 other than the initial approximation of the formulae 108).

The approximated probabilistic model produced by the iterative approximation component 114 can be inputted to a relational learning engine 120. It is to be appreciated that the relational learning engine 120 can be substantially any type of relational learning engine. Further, the relational learning engine 120 can output a most probable explanation (MPE) world based on the approximated probabilistic model, wherein the MPE world includes valuations of the relations included in the approximated probabilistic model (e.g., the relations 106 included in the probabilistic model 102).

A consistency check component 122 can receive the MPE world outputted by the relational learning engine 120. The consistency check component 122 can evaluate whether the MPE world from the relational learning engine 120 satisfies axioms included in the probabilistic model 102 (e.g., the axioms included in the formulae 108). If the consistency check component 122 determines that the probabilistic model 102 includes one or more axioms violated by the MPE world outputted by the relational learning engine 120, then the consistency check component 122 can form a set of conflict axioms (e.g., from the axioms included in the formulae 108 of the probabilistic model 102) identified as being violated by the MPE world generated by the relational learning engine 120. The set of conflict axioms can be a subset of the axioms included in the probabilistic model 102. Further, the iterative approximation component 114 can construct an updated approximation of the probabilistic model 102 based upon the set of conflict axioms detected by the consistency check component 122 (e.g., the axiom selection component 118 can selectively add axiom(s) to the approximation of the formulae 108 as a function of the set of conflict axioms). The foregoing can be repeated so long as the consistency check component 122 determines that the probabilistic model 102 includes at least one axiom violated by an MPE world outputted by the relational learning engine 120. Thus, similar to above, the updated approximation of the probabilistic model 102 can be inputted to the relational learning engine 120, the consistency check component 122 can evaluate the MPE world outputted from the relational learning engine 120 based upon the updated approximation of the probabilistic model 102, and so forth. Accordingly, one or more of the axioms included in the probabilistic model 102 can be iteratively added to subsequent approximated probabilistic models while MPE worlds returned from the relational learning engine 120 respectively corresponding to the subsequent approximated probabilistic models violate at least one of the axioms of the probabilistic model 102. Alternatively, if the consistency check component 122 determines that the probabilistic model 102 lacks an axiom violated by the MPE world generated by the relational learning engine 120, then an output component 124 can output the MPE world 126.

CEGAR can be used in the system 100 to handle axioms efficiently during relational learning. According to various embodiments described herein, the probabilistic model 102 can be a Markov Logic Network (MLN). Suppose the probabilistic model 102 is an MLN L with formulae [symbol] = [symbol] _{S} (e.g., the formulae 108), where [symbol] is the set of axioms in [symbol] , and [symbol] _{S} is the set of soft formulae in [symbol] . The soft formulae selection component 116 can select the soft formulae from the formulae 108 for inclusion in an initial approximation of the formulae 108 included in the inputted MLN, and the axiom selection component 118 can omit axioms from the formulae 108 from being included in the initial approximation of the formulae 108. Thus, let [symbol] ₀= [symbol] _{S} be an initial set of formulae (e.g., initial approximation of the formulae 108). As noted above, the underlying relational learning engine 120 can be invoked with the set of formulae [symbol] ₀. Suppose the relational learning engine 120 returns a world ω₀. Then, the consistency check component 122 checks for axioms in [symbol] that are violated by ω₀. The axiom selection component 118 can selectively instantiate axioms on the values of the relations from ω₀ which witness these violations, and add these axioms to [symbol] ₀ resulting in a larger set of formulae [symbol] ₁. Next, the relational learning engine 120 can again be invoked with the larger set of formulae [symbol] ₁, and the iterative process can continue until a world \hat{ω} that satisfies all the axioms from the formulae 108 is obtained.

Lazily adding axioms as described herein can lack an effect on the optimality of the relational learning solution. For instance, satisfied axioms do not contribute to the weight assigned to a world, whereas soft formulae do contribute to the weight assigned to a world. As a result, if a world ω is inferred for an MLN L without taking into account a set of axioms [symbol] , and the world ω happens to also satisfy the axioms [symbol] , then adding [symbol] to the MLN does not affect the weight of the world ω. Accordingly, axioms can be lazily added, while the inferred solution can have the same weight as an optimal solution obtained by adding all the axioms eagerly, assuming that the relational learning engine 120 returns the optimal solution.

Moreover, the world ω inferred by the relational learning engine 120 can be stored in a relational database. The consistency check component 122 can check if the world ω inferred by the relational learning engine 120 satisfies the axioms [symbol] . Such checking is nontrivial since the world ω is typically very large. The consistency check component 122 can efficiently search for parts of the world ω that violate [symbol] using database querying (e.g., SQL queries, etc.), for example.

Further, the iterative CEGAR process performed by the system 100 sometimes can include a large number of iterations, each of which add formulae forming particular patterns (e.g., axioms added by the axiom selection component 118). Accordingly, as described herein, a technique to detect these patterns and suitably generalize the axioms added during refinement can be utilized, thereby reducing the number of iterations to convergence.

As noted above, the probabilistic model 102 used for relational learning can be a MLN. Below is an exemplary description of a MLN; it is to be appreciated, however, that the claimed subject matter is not limited to this example. A Markov Logic Network (MLN) L= [symbol] , [symbol] , [symbol] is a triple, where:

[symbol] ={D₁, D₂, . . . } is a set of finite domains (e.g., the domains 104).

[symbol] ={R₁, R₂, . . . } is a set of relations (e.g., the relations 106) over these domains. The existence of a function [symbol] that maps each relation in [symbol] to a schema is assumed. For instance, [symbol] (R₁) could be D₁×D₃×D₅, which specifies that R₁ is a three-column relation and R₁⊂D₁×D₃×D₅.

[symbol] is a set of weighted formulae (e.g., formulae 108) of the form {w₁:F₁, w₂:F₂, . . . , wₙ:Fₙ}, where each of the wᵢ∈[0, 1] is a real number, and each Fᵢ is a formula in a Domain Relational Calculus (DRC) over [symbol] . Free variables in the formulae Fᵢ, 1≦i≦n, are assumed to be universally quantified.

In the Domain Relational Calculus (DRC), a relation R is viewed as a predicate: ∀ c̅∈ [symbol] (R). R( c̅) [symbol] c̅∈R. In the DRC, a term is either a constant c or variable x. Atoms are defined as follows: if R is a predicate with arity k and t₁, . . . , tₖ are terms, then R(t₁, . . . , tₖ) is an atom; and if t₁ and t₂ are terms, then t₁Θt₂ is an atom, where Θ∈{<, ≦, =, ≠, >, ≧}.

Further, formulae are defined as follows. An atom is a formula. If F₁ and F₂ are formulae, then so are [symbol] F, F₁ [symbol] F₂, F₁ [symbol] F₂, and F₁ [symbol] F₂. If F(x) is a formula, where x is a variable, then ∃x. F(x) and ∀x. F(x) are also formulae.

An axiom is a weighted formula [symbol] F,w [symbol] with weight w∈{0,1}. Axioms represent formulae in an MLN that must be satisfied or violated. Let [symbol] (L) be the set of axioms in an MLN L.

Moreover, a weighted formula w:F can be negated in two ways. The weighted formula can be negated by flipping the weight, resulting in (1−w):F. Alternatively, the weighted formula can be negated by negating the formula, resulting in w: [symbol] F.

The two weighted formulas (1−w):F and w: [symbol] F are equivalent. Also, the formula w:F is equivalent to the formula (1−w): [symbol] F. The relational learning and inference algorithms described herein respect these equivalences between weighted formulae.

Moreover, an MLN represents a probability distribution over possible worlds. Formally, let L= [symbol] , [symbol] , [symbol] be an MLN. Each relation R∉ [symbol] can be associated with a set of Boolean random variables [symbol] _{R}={X_{R, c̅}| c̅∉ [symbol] (R)} defined as follows.

$${𝒳}_{R , \overline{c}} = \{ \begin{matrix}true & if R ( \overline{c} ) \\ false & otherwise\end{matrix} \qquad ( 4 )$$

The schema function [symbol] can be generalized to both variables and formulas. Let w:F∉ [symbol] be a weighted formula, with F defined over relations R₁, . . . , Rₘ (where m is an integer), and having free variables x₁, . . . , xₙ that take values from domains D₁, . . . , Dₙ (where n is an integer), respectively. For a variable x₁, [symbol] (xᵢ) can be defined to be its appropriate domain Dᵢ. For the formula F, [symbol] (F)= [symbol] (x₁)× . . . [symbol] (xₙ) can be set, which is equal to D₁, . . . , Dₙ.

Let [symbol] _{F}=∪_{R∉{R}_{₁}_{, . . . , R}_{ₘ}_{}} [symbol] _{R} be the set of random variables associated with the formula F, and let [symbol] _{L}= [symbol] [symbol] _{F} be the set of all random variables associated with the MLN L. It is noted that a valuation to variables in [symbol] _{R} completely specifies the relation R, and that a valuation to variables in [symbol] _{L} completely specifies relations and results in a world for the MLN L.

Given a formula F, let F [t/x] denote the formula obtained by substituting free occurrences of variable x in F with the term t. For each c̅∉ [symbol] (F), let c̅↓Rᵢ denote the projection of c̅ to the columns specified by [symbol] (Rᵢ). Let [symbol] _{F, c̅}={X_{R}_{₁}_{, c̅↓R}_{₁}, . . . , X_{R}_{ₘ}_{, c̅↓R}_{ₘ}}, and let F _{c̅}( [symbol] _{F, c̅})=F[c₁/x₁, . . . , cₙ/xₙ][X_{R}_{₁}_{, c̅↓R}_{₁}/R₁( . . . ), . . . , X_{R}_{ₘ}_{, c̅↓R}_{ₘ}/Rₘ( . . . )]. Intuitively, the formula F _{c̅} is obtained by (1) first substituting xᵢ for each cᵢ for each of 1≦i≦n, and then (2) substituting every relation R together with its constant arguments (denoted by R( . . . )) with the variable X_{R, c̅↓}.

The potential function Φ [symbol] _{F,w} [symbol] for a weighted formula [symbol] F,w [symbol] ∉ [symbol] is defined as follows:

$${Φ}_{〈 F , w 〉} ( {𝒳}_{F} ) = {\prod }_{\overline{c} ∈ ( {D}_{1} \times … \times {D}_{n} )} w [ {F}_{\overline{c}} ( {𝒳}_{F , \overline{c}} ) ] + ( 1 - w ) [ {F}_{\overline{c}} ( {𝒳}_{F , \overline{c}} ) ] \qquad ( 5 )$$

where [F] is an indicator function for formula F that evaluates to 1 if F is true and is 0 otherwise. The probability distribution represented by the MLN L is the product of the potential function for all weighted formulae in [symbol] :

$${P}_{L} ( {𝒳}_{L} ) = {\prod }_{〈 F , w 〉 ∈ ℱ} {Φ}_{〈 F , w 〉} ( {𝒳}_{F} ) \qquad ( 6 )$$

Equation 6 allows for specifying various relational learning problems formally using probabilistic inference. A simple relational learning problem relates to learning the values to the relations given a corpus of incomplete values called evidence. Formally, evidence ε can be thought of as giving values v_{ε} to a subset [symbol] _{ε}⊂ [symbol] _{L} and finding the most likely values of the remaining variables [symbol] _{ε}\ [symbol] _{L} as specified by the distribution. The MPE given evidence ε is defined as the world with maximum probability in the distribution obtained after fixing the random variables in [symbol] _{ε} to values v_{ε}:

$${MPE}_{L} ( ɛ ) {=}^{def} \begin{matrix}arg max \\ {𝒳}_{L} \backslash {𝒳}_{ɛ}\end{matrix} {P}_{L} ( {𝒳}_{L} ) [ {v}_{ɛ} / {𝒳}_{ɛ} ] \qquad ( 7 )$$

The evidence oftentimes corresponds to a set of relations that are completely known (if a relation R is known, then ∀X∉ [symbol] _{R}, X is either true or false with probability 1.0 as determined by the evidence), and thus, the most probable explanation for the remaining relations in [symbol] can be inferred.

A query corresponds to relations whose values are desired to be estimated. The set of query relations can be denoted by [symbol] ⊂ [symbol] . Further, a set of query random variables can be defined to be [symbol] [symbol] =∪_{R∉} [symbol] [symbol] _{R}. Given a technique to perform MPE inference, a query [symbol] given evidence ε can be answered by first computing a world MPE_{L} (ε), and then projecting the world to the query relations [symbol] .

Computation of the MPE world of an MLN is NP-hard (non-deterministic polynomial-time hard). Conventionally, various machine learning techniques (e.g., performed by the relational learning engine 120) can be used to estimate the MPE solution for an MLN given the evidence. An MPE inference on MLNs can employ a stochastic local search procedure, for instance. For example, MPE inference can include two phases. In the first phase, which is essentially quantifier elimination, a large weighted satisfiability (SAT) formula can be constructed from the MLN, and in the second phase, an algorithm can search for an MPE solution. For example, the algorithm can randomly select a violated clause, fix the violated clause by flipping the truth value of an atom in it, and repeat. This can be a heuristic-based algorithm that may not achieve an optimal solution. However, axioms place a significant stress on such inference algorithms. In contrast, the system 100 can facilitate more efficient computation of an MPE world of an MLN by initially omitting and iteratively adding axioms to approximations of the MLN, from which the MPE world can be computed.

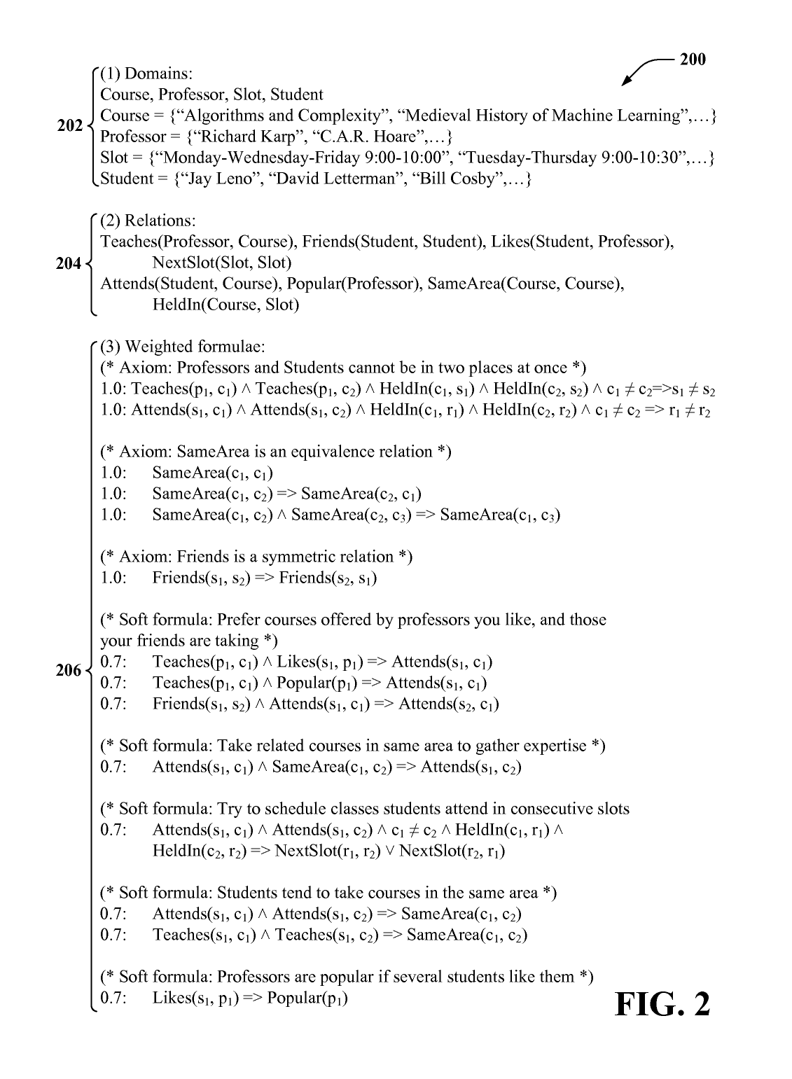

Now turning to FIG. 2, illustrated is an exemplary Markov Logic Network (MLN) 200. For example, the MLN 200 can be an example of the probabilistic model 102; yet, it is contemplated that the claimed subject matter is not so limited. The MLN 200 relates to scheduling courses in a Computer Science Department; it is to be appreciated, however, that the MLN 200 is provided as an example, and the claimed subject matter is not limited to this example.

FIG. 2 shows an example MLN L= [symbol] , [symbol] , [symbol] (e.g., the MLN 200) for scheduling classes in a Computer Science department. The MLN 200 includes a domains section 202 which defines the domains [symbol] or attributes of relations in the database. The domains include Course (set of courses offered), Professor (set of professors in the department), Slot (set of slots in a week), and Student (the set of students in the department).

Further, the MLN 200 includes a relations section 204 that defines the set of relations [symbol] of interest in the database. The relations include the following:

Teaches(p, c): Professor p teaches a course c.

Friends(s₁, s₂): Student s₁ is a friend of student s₂.

Likes(s, p): Student s likes professor p.

NextSlot(s₁, s₂): Slot s₂ immediately follows slot s₁.

Attends(s, c): Student s attends course c.

Popular(p): Professor p is popular.

SameArea(c₁, c₂): Courses c₁ and c₂ are in the same subarea of computer science.

HeldIn(c, s): Course c is scheduled in slot s.

Further, the MLN 200 includes a weighted formulae section 206 where the axioms and soft formulae in Y are defined. The first two axioms in the weighted formulae section 206 state that professors and students cannot be in two places at the same time. The next subset of axioms in the weighted formulae section 206 encode the fact that the relation SameArea is an equivalence relation (e.g., SameArea is a reflexive, symmetric and transitive relation). Moreover, the weighted formulae section 206 includes an axiom that states that the relation Friends is a symmetric relation.

A first set of soft formulae in the weighted formulae section 206 specifies a student's preference for courses offered by professors that she likes and for the courses taken by her friends. These formulae are associated with a weight or confidence of 0.7 in the example shown in FIG. 2; yet, it is to be appreciated that the claimed subject matter is not limited to the weight being 0.7. A next soft formula states that it is likely that students take courses in the same area with the intention of gaining expertise in that area. Moreover, the weighted formulae section 206 includes a soft formula that tries to schedule classes for a student in consecutive slots for the sake of convenience. Further, the weighted formulae section 206 includes a soft formula that groups two courses into the same area if there are many students who take both courses. The weighted formulae section 206 also includes a soft formula which states that professors are popular when there are many students who like them.

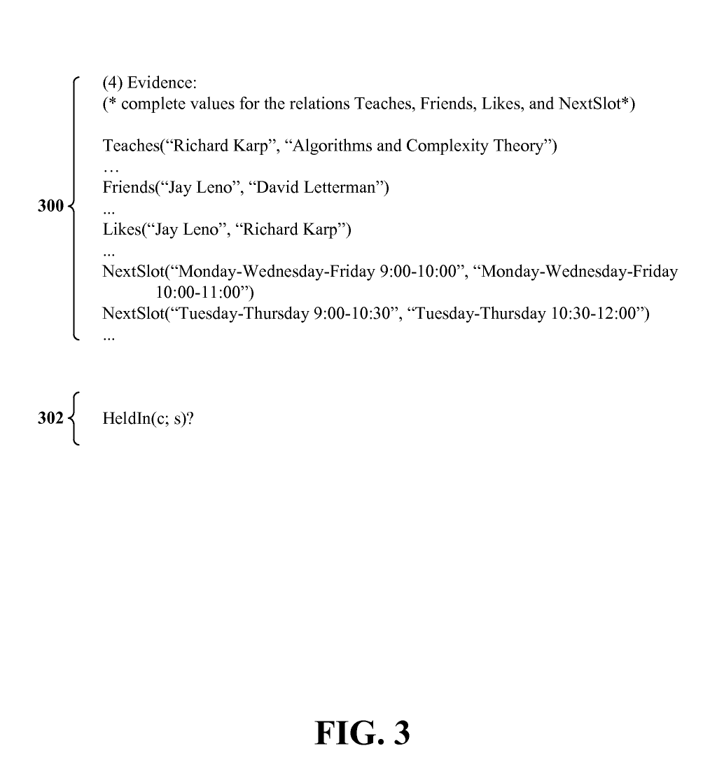

FIG. 3 illustrates exemplary evidence and an exemplary query associated with the MLN 200 of FIG. 2. As noted above, the evidence can be a corpus of data that includes an incomplete valuation of relations (e.g., relations included in the relations section 204 of the MLN 200 of FIG. 2). An evidence section 300 specifies known relations. For example, valuations of the relations Teaches, Friends, Likes and NextSlot are known as depicted in the example shown in FIG. 3. Moreover, a query section 302 specifies query relations of interest. Pursuant to the example shown in FIG. 3, the query relations of interest can be the HeldIn relation, which is a schedule that assigns a course to a slot and a quarter.

Consider the relation SameArea defined in the relations section 204 of FIG. 2. This is an equivalence relation and is specified by the following three axioms.

SameArea is reflexive:
∀c₁. SameArea(c₁, c₁).

SameArea is symmetric:
∀c₁c₂. SameArea(c₁, c₂) [symbol] SameArea(c₂, c₁).

SameArea is transitive:
∀c₁c₂c₃. SameArea(c₁, c₂) [symbol] SameArea(c₂, c₃) [symbol] SameArea(c₁, c₃).
   Since these are axioms with variables universally quantified, eagerly instantiating these variables over their respective domains would result in an intractable number of instantiated axioms, and thus, impose a severe burden (in terms of scalability and precision of solution) on the relational MPE inference solver (e.g., the relational learning engine 120 of FIG. 1). Accordingly, the MLN 200 can be iteratively approximated as described herein to mitigate such burden on the relational MPE inference solver.

More particularly, a CEGAR loop can be used to construct a series of approximations of the MLN 200 over which inference is performed iteratively in order to compute a MPE solution. Further, the MPE solution for an approximate MLN can be checked for consistency with respect to axioms defined in the original input MLN (e.g., the MLN 200).

Again, reference is made to FIG. 1. The system 100 can perform a Bayez algorithm for efficiently computing MPE_{L}(ε) (e.g., the MPE world 126) as defined in Equation 7 for an input MLN L (e.g., the probabilistic model 102) and evidence ε (e.g., the evidence 112). Bayez provides a framework for systematically combining relational MPE inference algorithms with logical inference algorithms that check consistency of the MPE solutions with respect to the axioms defined by [symbol] (L). An example of a Bayez algorithm that can be implemented by the system 100 is set forth in the pseudocode below; however, it is to be appreciated that the claimed subject matter is not so limited.

Algorithm Bayez

```
input:
  L = [symbol]   , [symbol]   , [symbol]   : MLN
  ε: Evidence
  f_{gen}: Boolean flag for generalization
output:
  ω_{MPE}: MPE solution
1. [symbol]   ₐₚₚᵣₒₓ := [symbol]    \ [symbol]    (L)
2. loop
3. [symbol]   := Ø
4. Lₐₚₚᵣₒₓ = [symbol]   , [symbol]   , [symbol]   ₐₚₚᵣₒₓ [symbol]
5. (*Call relational MPE solver *)
6. ωₐₚₚᵣₒₓ := SOLVE_{MPE} (Lₐₚₚᵣₒₓ, ε)
7. (*Compute conflicts*)
8. for each w : F ∈ [symbol]    (L) do
9. if w = 1.0 then
10. [symbol]   := QUERY(ωₐₚₚᵣₒₓ, [symbol]   F)
11. [symbol]   := [symbol]    ∪ {1.0 : F( c̅)| c̅ ∈ [symbol]   }
12. else
13. [symbol]   := QUERY(ωₐₚₚᵣₒₓ, F)
14. [symbol]   := [symbol]    ∪ {0.0 : F( c̅)| c̅ ∈ [symbol]   )
15. end if
16. end for
17. if f_{gen} = true then
18. [symbol]   := GENERALIZE (Lₐₚₚᵣₒₓ, [symbol]   , [.])
19. end if
20. if [symbol]    ≠ Ø then
21. [symbol]  ₐₚₚᵣₒₓ := [symbol]   ₐₚₚᵣₒₓ ∪ [symbol]
22. else
23. ω_{MPE} := ωₐₚₚᵣₒₓ
24. return ω_{MPE}
25. end if
26. end loop
```

As described above in the Bayez algorithm, the input is an MLN L= [symbol] , [symbol] , [symbol] (e.g., the probabilistic model 102) together with a set of evidence relations ε (e.g., the evidence 112). The output of the algorithm is a world ω_{MPE} (e.g., the MPE world 126) that is an MPE solution satisfying Equation 7.

The CEGAR loop of the Bayez algorithm is described in lines 2-26. In line 6, an approximation Lₐₚₚᵣₒₓ= [symbol] , [symbol] , [symbol] ₐₚₚᵣₒₓ [symbol] of the input MLN L is constructed (e.g., by the iterative approximation component 114). Initially, Lₐₚₚᵣₒₓ is the input MLN L without any axioms (modeled in line 1 by setting [symbol] ₐₚₚᵣₒₓ to [symbol] \ [symbol] (L)). Next, in line 6, an off-the-shelf MPE solver SOLVE_{MPE}(Lₐₚₚᵣₒₓ,ε) (e.g., the relational learning engine 120) is invoked on the approximated MLN Lₐₚₚᵣₒₓ with the evidence ε. This results in an MPE world ωₐₚₚᵣₒₓ of the MLN Lₐₚₚᵣₒₓ.

Consistency of ωₐₚₚᵣₒₓ with the axioms [symbol] (L) of the input MLN L is checked and a set of conflict axioms [symbol] is computed in lines 8-16 (e.g., by the consistency check component 122). Further, for every axiom w:F, a set of tuples [symbol] ⊂ [symbol] (F) in ωₐₚₚᵣₒₓ that violate the axiom w:F is computed in lines 9-15 (e.g., by the consistency check component 122) (recall that [symbol] (F) is the product of the domains of the free variables in F). This is computed by the procedure Query called in lines 10 and 13. Since the formula F is in DRC, database querying can be used to select tuples in the world ωₐₚₚᵣₒₓ which violate F and project these tuples to [symbol] (F). The set of conflict axioms [symbol] is the set of instances of the axiom w:F over the set of tuples [symbol] , which is computed in lines 11 and 14. If the set [symbol] is empty, then the current solution ωₐₚₚᵣₒₓ respects axioms in [symbol] (L), the procedure stops, and ω_{MPE}=ωₐₚₚᵣₒₓ is returned (line 24) (e.g., by the output component 124). Otherwise, the set of weighted formulae [symbol] ₐₚₚᵣₒₓ is refined with [symbol] (line 21) (e.g., by the iterative approximation component 114).

For example, consider the SameArea relation defined in the relations section 204 of FIG. 2. The SameArea relation is an equivalence relationship. Without the axiom of transitivity present in [symbol] ₐₚₚᵣₒₓ, a possible world of Lₐₚₚᵣₒₓ (on line 7) may have both SameArea(“Static Analysis”, “Program Analysis”) and SameArea(“Program Analysis”, “Abstract Interpretation”), but not SameArea(“Static Analysis”, “Abstract Interpretation”). In this case, [symbol] (on line 10) will have the tuple c̅=(“Static Analysis”, “Program Analysis”, “Abstract Interpretation”), and the conflict F( c̅) added on line 11 can be:
SameArea(“Static Analysis”, “Program Analysis”) [symbol] SameArea(“Program Analysis”, “Abstract Interpretation”) [symbol] SameArea(“Program Analysis”, “Abstract Interpretation”).
   This axiom can be added to the approximation of the formulae [symbol] ₐₚₚᵣₒₓ, which can prevent this spurious world from appearing again in a future iteration.

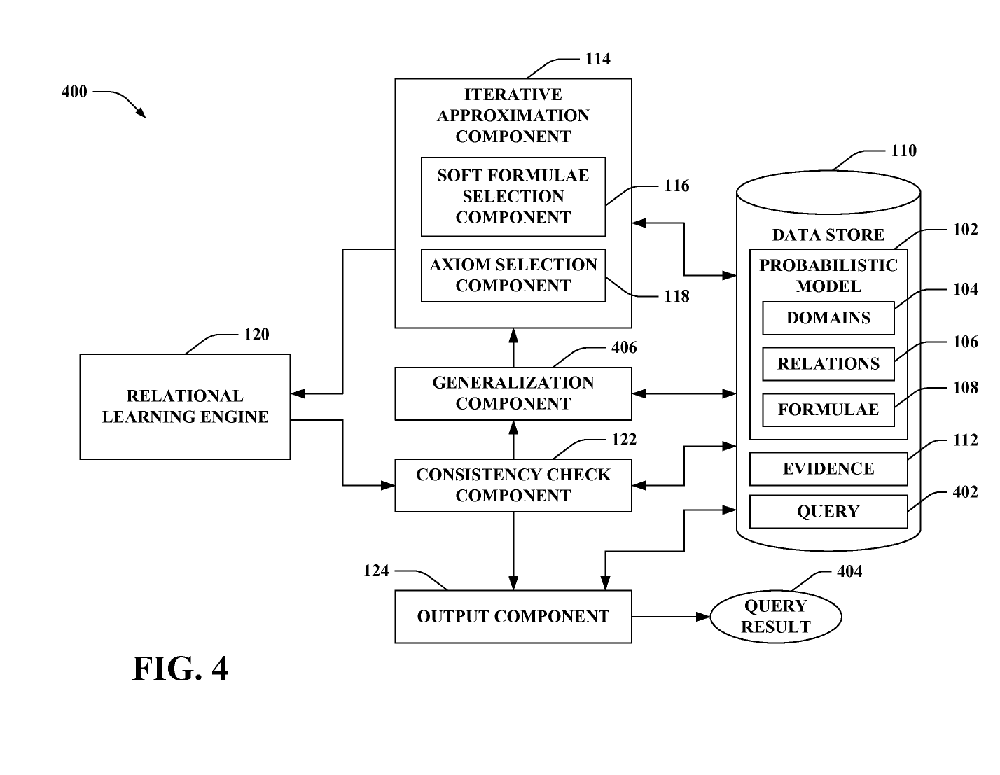

When the generalization flag f_{gen} is set to true, the set of conflict axioms can be generalized via a generalize procedure (lines 17-19). Generalization is discuss further in connection with FIG. 4

Database querying can be performed in lines 10 and 13 to check consistency of the world ωₐₚₚᵣₒₓ (e.g., by the consistency check component 122). Use of database querying can enhance efficiency of the Bayez algorithm, since typical sizes of the world ωₐₚₚᵣₒₓ can range from tens of thousands to hundreds of thousands. For example, DRC can be used for the language of the formulas. Following this example, use of DRC as the language of the formulas can allow for representing worlds in a database, and using database querying to check consistency of the world with respect to axioms.

Moreover, iteratively adding axioms when using the Bayez algorithm does not detrimentally impact precision. This is because satisfied axioms do not contribute to the weight assigned to a world, whereas soft formulas do (e.g., as shown in equation 5). Thus, as long as the axioms are satisfied, the weight of a world in an MLN with or without axioms is the same (e.g., so long as no other world can satisfy the axioms and have a higher weight). Assuming that the relational learning engine 120 is optimum (e.g., returning a world with a highest weight that satisfies the axioms included in the approximation of the MLN), then it can be established that no other world can satisfy the axioms and have a higher weight.

Further, the Bayez algorithm can returns an exact MPE solution provided the MPE solver SOLVE_{MPE} (e.g., the relational learning engine 120) returns exact MPE solutions. However, conventional MPE solvers are based on probabilistic and approximation algorithms and typically cannot handle axioms precisely. Yet, with imprecise MPE solvers, the Bayez algorithm can improve both runtime and precision of the inference based on the handling of the axioms as described herein. Thus, lazily instantiating axioms with the system 100 can advantageously impact precision and performance. For example, conventional relational MPE solvers can be tuned towards solving weighted formulae efficiently. Therefore, reducing the number of axioms inputted to such relational MPE solvers by approximating the MLNs can improve the quality of the results, thereby enhancing precision. According to another example, lazily instantiating axioms also can reduce the complexity of the input to the relational solver (e.g., an approximation of the MLN rather than the MLN is inputted to the relational learning engine 120), and thus increases scalability. In contrast, existing approaching eagerly instantiate axioms, which can lead to non-scalability.

With reference to FIG. 4, illustrated is a system 400 that generalizes conflict axioms selected for inclusion in an approximation of a probabilistic model (e.g., the probabilistic model 102) for statistical relational learning. The system 400 includes the data store 110, the iterative approximation component 114, the relational learning engine 120, the consistency check component 122, and the output component 124. The data store 110 can include the probabilistic model 102 (e.g., the domains 104, the relations 106, and the formulae 108) and the evidence 112.

Further, the data store 110 can include a query 402. The query 402 corresponds to values of one or more of the relations 106 desired to be estimated. According to an example, if the consistency check component 122 determines that the probabilistic model 102 lacks an axiom violated by an MPE world generated by the relational learning engine 120, then the output component 124 can output a query result 404. Following this example, the output component 124 can detect the query result 404 pertaining to the query 402 from the MPE world determined by the consistency check component 122 to lack a violated axiom.

Moreover, the system 400 includes a generalization component 406 that can generalize conflict axioms detected by the consistency check component 122. The generalization of the conflict axioms provided by the generalization component 406 can be utilized by the iterative approximation component 114 (e.g., the axiom selection component 118) to construct an updated approximation of the probabilistic model 102. Accordingly, generalization can accelerate the CEGAR process by reducing a number of iterations of adding conflict axioms when constructing approximations of the probabilistic model 102.

According to an example, the generalization component 406 can implement a generalize algorithm as described in the following pseudocode; yet, it is to be appreciated that the claimed subject matter is not so limited.

rec algorithm GENERALIZE

```
input:
  L: MLN [symbol]
  : set of conflict axioms
  σ: map from variables to values
parameters:
  low: a floating point number
  high: a floating point number
output: [symbol]
  : set of generalized conflict axioms
1. [symbol]    := Ø
2. for all φ ∈ [symbol]    (L) do
3. for all χ ∈ {y ∈ vars(φ)|σ(y) =⊥} do
4. for all c ∈ S(χ) such that c also appears in [symbol]    do
5. σ(χ) := c
6. [symbol]  ′ := {φ′ ∈ [symbol]    | φ[σ] [symbol]    φ′}
7. if | [symbol]  ′| < low × |σ, φ| then
8. (* Do not generalize*)
9. [symbol]   := [symbol]    ∪ [symbol]   ′
10. else if | [symbol]  ′| < high × |σ, φ| then
11. (* Search for finer granularity generalization *)
12. [symbol]   := [symbol]    ∪ GENERALIZE(L, [symbol]   , σ)
13. else
14. (* Generalize at this level of granularity *)
15. [symbol]   := [symbol]    ∪ {φ[σ]}
16. end if
17. [symbol]   := [symbol]    \ [symbol]   ′
18. end for
19.  end for
20. end for
21. return [symbol]
```

The generalize algorithm implement by the generalization component 406 can be invoked by the Bayez algorithm set forth herein. Inputs to the generalize algorithm (e.g., inputs to the generalization component 406) can include an MLN L (e.g., the probabilistic model 102), a set [symbol] ={φ₁, φ₂, . . . , . . . } of conflict axioms (e.g., detected by the consistency check component 122), and a partial map σ from free variables to their respective domains. For a variable x, the notation σ(x)=⊥ can be used to denote that σ(x) is undefined. The generalize algorithm is a recursive procedure. At the top level, the generalize algorithm can be invoked at line 18 of the Bayez algorithm as described above, with a set to the empty map (e.g., σ maps all variables to ⊥).

The generalize algorithm searches for a generalized set of conflict axioms [symbol] ={ψ₁, ψ₂, . . . , . . . } that entails the input set [symbol] of conflict axioms (e.g., [symbol] ) and [symbol] entails as few φ∈ [symbol] as possible. For an axiom w:F, the notation [|w:F|] can be used to denote the formula F if w is 1, and the formula [symbol] F if w is 0. For instance, the axiom w₁:F₁ entails w₂:F₂ (denoted as w₁:F₁ [symbol] w₂:F₂) if and only if the following holds.

[|w₁:F₁|] [symbol] [|w₂:F₂|] (8)

The generalize algorithm takes two parameters, low and high, which are floating point numbers. These parameters control the extent to which the algorithm generalizes [symbol] to [symbol] .

The outer loop of the generalize algorithm (lines 2-20) iterates through each axiom in φ∉ [symbol] (L). The inner loop (lines 3-19) checks if some instantiation of φ can be added as a generalized axiom in [symbol] . In line [symbol] , the algorithm heuristically picks an unbound variable x and binds it to a constant c∉ [symbol] (x) such that c also appears in [symbol] . Next, in line 6, the generalize algorithm collects the subset [symbol] ′ of [symbol] such that all axioms in [symbol] ′ are entailed by φ[σ], where φ[σ] denotes the formula φ with variables substituted to constants as defined by the partial map σ. If a variable y in φ is unbound in σ, then y is left free in the substitution φ[σ].

The if-then-else statements in lines 7-16 decide how to generalize [symbol] ′. Let |σ,φ| denote the product of the domain sizes of unbound variables in σ that are free in φ. Intuitively, |σ,φ| represents the set of all grounding that can be covered by the generalized axiom φ[σ] and [symbol] ′ is the size of the subset of these groundings that actually occur in [symbol] .

Accordingly, there are 3 cases provided in lines 7-16. If the size of [symbol] ′ is less than low×|σ,φ|, then the algorithm decides that it is better to use [symbol] ′ directly in [symbol] without generalizing (lines 8-9). If the size of [symbol] ′ is greater than or equal to high×|σ,φ|, then the algorithm decides that there is significant overlap between [symbol] ′ and the set of generalizations represented by φ[σ] and decides to use φ[σ] to generalize [symbol] ′ (lines 14-15). If the size of [symbol] ′ is greater than or equal to low×|σ,φ| and less than high×|σ,φ|, then the algorithm decides to try generalizations of finer granularity and recursively calls the generalize algorithm with the updated map σ (lines 11-12). In the three cases, [symbol] entails [symbol] ′. Moreover, [symbol] entails [symbol] in the three cases.

Again, reference is made to the exemplary MLN 200 of FIG. 2. According to an example, it can be assumed that the following facts are part of the world ωₐₚₚᵣₒₓ outputted by the relational learning engine 120 in some arbitrary iteration i of the Bayez algorithm: Attends(Student1, Course 1), Attends(Student1, Course3), HeldIn(Course1, Slot1), and HeldIn(Course3, Slot1). This world ωₐₚₚᵣₒₓ violates the following axiom that states that students cannot be in two places at the same time.
1.0: Attends(s₁, c₁) [symbol] Attends(s₁, c₂) [symbol] HeldIn(c₁, r₁) [symbol]
   HeldIn(c₂, r₂) [symbol] c₁≠c₂ [symbol] r₁≠r₂
      In order, to rule out this world ωₐₚₚᵣₒₓ, the following conflict axiom can be added by the iterative approximation component 114 (e.g., the axiom selection component 118) to the set of weighted formulae for the approximate MLN in next iteration of Bayez.
1.0: [symbol] Attends(Student1, Course1) [symbol]
   [symbol] Attends (Student1, Course3) [symbol]
   [symbol] HeldIn(Course1, Slot1) [symbol]
   [symbol] HeldIn(Course3, Slot1)

However, resolving conflicts at such a fine granularity may result in a prohibitively large number of iterations and as a result, the following facts that violate the same axiom above may appear in worlds computed by subsequent iterations (e.g., i, i+1, i+2, i+3, etc.) of the Bayez algorithm.

| | | |
|---|---|---|
| i | Attends(Student1, Course1) | Attends(Student1, Course3) |
| | HeldIn(Course1, Slot1) | HeldIn(Course3, Slot1) |
| i + 1 | Attends(Student2, Course1) | Attends(Student2, Course3) |
| | HeldIn(Course1, Slot1) | HeldIn(Course3, Slot1) |
| i + 2 | Attends(Student3, Course1) | Attends(Student3, Course3) |
| | HeldIn(Course1, Slot1) | HeldIn(Course3, Slot1) |
| i + 3 | Attends(Student4, Course1) | Attends(Student4, Course3) |
| | HeldIn(Course1, Slot1) | HeldIn(Course3, Slot1) |

Furthermore, it is possible that this sequence of conflict axioms can continue for substantially any number of iterations. For instance, there can be several reasons for the foregoing behavior such as the popularity of Course1 and Course3. Therefore, the generalization component 406 can identify a generalized conflict axiom that entails many possible conflict axioms in future iterations so as to reduce the overall number of iterations of the Bayez algorithm. For instance, the following conflict axiom is a generalized conflict axiom that rules out the violating facts mentioned before.
1.0: [symbol] Attends(x, Course1) [symbol] Attends(x, Course3) [symbol]
   [symbol] HeldIn(Course1, Slot1) [symbol] HeldIn(Course3, Slot1)
      According to an example, the above conflict axiom can be outputted by the generalization component 406 as opposed to the following generalized conflict axiom (e.g., based on the if-then-else statements in lines 7-16 of the generalize algorithm).
1.0: [symbol] Attends(x, y) [symbol] Attends(x, Course3) [symbol]
   [symbol] HeldIn(x, Slot1) [symbol] HeldIn(Course3, Slot1)
      Following this example, the second conflict axiom can have the same effect as the earlier one, but it can include many unnecessary instantiations which can adversely affect the performance of the relational MPE solver SOLVE_{MPE} (e.g., the relational learning engine 120).

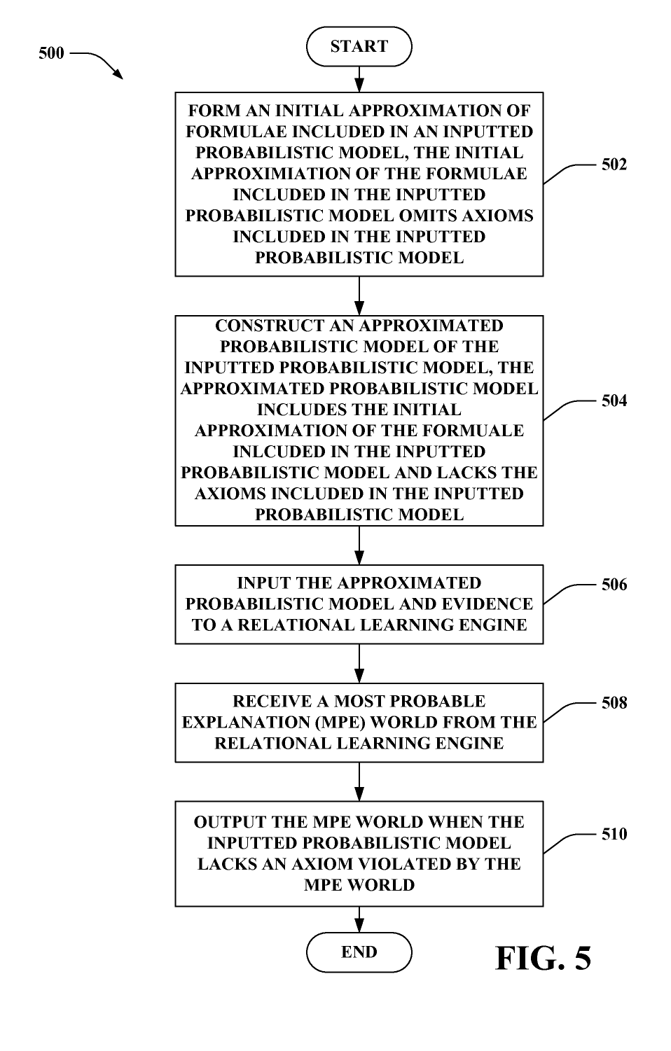

FIGS. 5-7 illustrate exemplary methodologies relating to approximating a probabilistic model for statistical relational learning. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 5 illustrates a methodology 500 for approximating an inputted probabilistic model for statistical relational learning. At 502, an initial approximation of formulae included in an inputted probabilistic model can be formed. The initial approximation of the formulae included in the inputted probabilistic model omits axioms included in the inputted probabilistic model. At 504, an approximated probabilistic model of the inputted probabilistic model can be constructed. The approximated probabilistic model can include the initial approximation of the formulae included in the inputted probabilistic model and can lack the axioms included in the inputted probabilistic model.

At 506, the approximated probabilistic model and evidence can be inputted to a relational learning engine. For example, the evidence can comprise existing valuations of a subset of relations included in the inputted probabilistic model (e.g., the evidence can be a corpus of data that includes incomplete valuations of the relations included in the inputted probabilistic model). At 508, a most probable explanation (MPE) world can be received from the relational learning engine. The MPE world, for instance, can comprise valuations for the relations included in the inputted probabilistic model. At 510, the MPE world can be outputted when the inputted probabilistic model lacks an axiom violated by the MPE world.

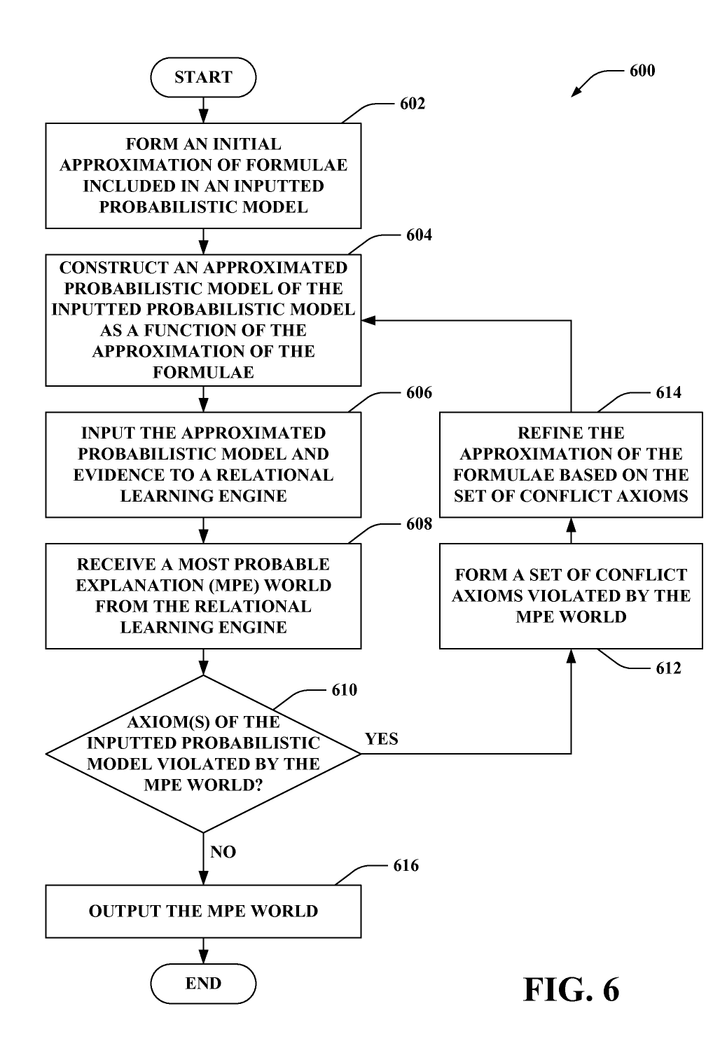

Now turning to FIG. 6, illustrated is a methodology 600 for iteratively approximating an inputted probabilistic model for statistical relational learning. At 602, an initial approximation of formulae included in an inputted probabilistic model can be formed. For example, the initial approximation of the formulae included in the inputted probabilistic model can omit axioms included in the inputted probabilistic model. At 604, an approximated probabilistic model of the inputted probabilistic model can be constructed as a function of the approximation of the formulae. Thus, for example, the approximated probabilistic model can be constructed based on the initial approximation of the formulae.

At 606, the approximated probabilistic model and evidence can be inputted to a relational learning engine. At 608, a most probable explanation (MPE) world can be received from the relational learning engine. At 610, whether the MPE world from the relational learning engine satisfies the axioms included in the inputted probabilistic model can be determined.

If one or more axioms of the inputted probabilistic model are determined to be violated by the MPE world at 610, then the methodology 600 continues to 612. At 612, a set of conflict axioms identified as being violated by the MPE world can be formed. The set of conflict axioms can be a subset of the axioms included in the inputted probabilistic model. At 614, the approximation of the formulae can be refined based on the set of conflict axioms. Moreover, the methodology 600 can return to 604, and the approximated probabilistic model can be constructed as a function of the approximation of the formulae. Pursuant to an example, an updated approximated probabilistic model of the inputted probabilistic model can be constructed as a function of the refined approximation of the formulae.

Alternatively, if the axioms of the inputted probabilistic model are determined to not be violated by the MPE world at 610, then the methodology 600 continues to 616. At 616, the MPE world can be outputted.

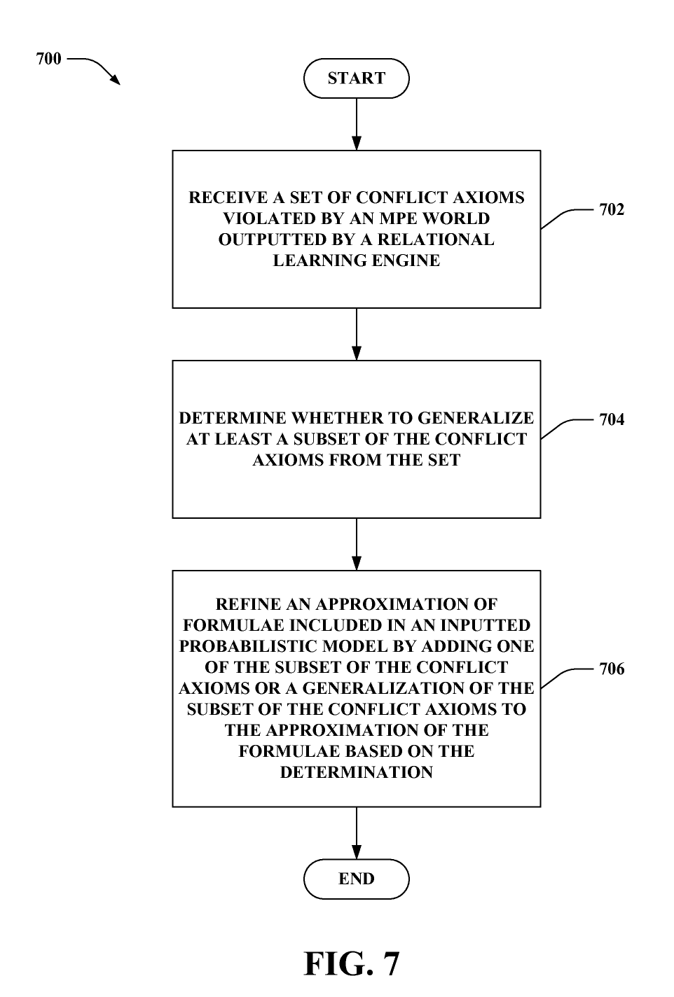

With reference to FIG. 7, illustrated is a methodology 700 for generalizing conflict axioms used for approximating an inputted probabilistic model. At 702, a set of conflict axioms violated by an MPE world outputted by a relational learning engine can be received. At 704, whether to generalize at least a subset of the conflict axioms from the set can be determined. At 706, an approximation of formulae included in an inputted probabilistic model can be refined by adding one of the subset of the conflict axioms or a generalization of the subset of the conflict axioms to the approximation of the formulae based on the determination.

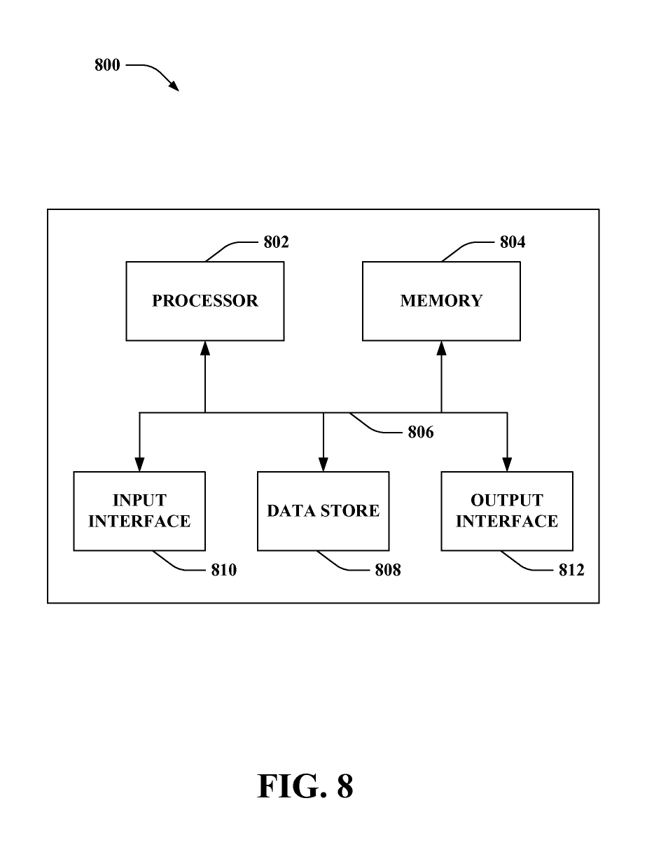

Referring now to FIG. 8, a high-level illustration of an exemplary computing device 800 that can be used in accordance with the systems and methodologies disclosed herein is illustrated. For instance, the computing device 800 may be used in a system that iteratively approximates a probabilistic model for statistical relational learning. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store a probabilistic model (e.g., domains, relations, formulae), an approximation of the probabilistic model, evidence, a query, an MPE world, and so forth.

The computing device 800 additionally includes a data store 808 that is accessible by the processor 802 by way of the system bus 806. The data store 808 may include executable instructions, a probabilistic model (e.g., domains, relations, formulae), an approximation of the probabilistic model, evidence, a query, an MPE world, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of approximating an inputted probabilistic model for statistical relational learning, comprising:
forming an initial approximation of formulae included in an inputted probabilistic model, wherein the initial approximation of the formulae included in the inputted probabilistic model omits axioms included in the inputted probabilistic model;
constructing an approximated probabilistic model of the inputted probabilistic model, wherein the approximated probabilistic model includes the initial approximation of the formulae included in the inputted probabilistic model and lacks the axioms included in the inputted probabilistic model;
inputting the approximated probabilistic model and evidence to a relational learning engine, wherein the evidence comprises existing valuations of a subset of relations included in the inputted probabilistic model;
receiving a most probable explanation (MPE) world from the relational learning engine, wherein the MPE world comprises valuations for the relations included in the inputted probabilistic model; and
outputting the MPE world when the inputted probabilistic model lacks an axiom violated by the MPE world.

2. The method of claim 1, further comprising evaluating whether the MPE world from the relational learning engine satisfies the axioms included in the inputted probabilistic model.

3. The method of claim 2, further comprising forming a set of conflict axioms violated by the MPE world when at least one of the axioms included in the inputted probabilistic model is identified as being violated by the MPE world, wherein the set of conflict axioms are a subset of the axioms included in the inputted probabilistic model.

4. The method of claim 3, wherein the MPE world is stored in a relational database, and wherein the set of conflict axioms violated by the MPE world is formed using database querying.

5. The method of claim 3, further comprising refining the approximation of the formulae included in the inputted probabilistic model based on the set of conflict axioms.

6. The method of claim 5, further comprising:
constructing an updated, approximated probabilistic model of the inputted probabilistic model as a function of the refined approximation of the formulae;
inputting the updated, approximated probabilistic model and the evidence to the relational learning engine;
receiving an updated MPE world from the relational learning engine; and
evaluating whether the updated MPE world from the relational learning engine satisfies the axioms included in the inputted probabilistic model.

7. The method of claim 5, further comprising:
determining whether to generalize at least a subset of the conflict axioms from the set of conflict axioms; and
refining the approximation of the formulae included in the inputted probabilistic model by adding one of the subset of the conflict axioms or a generalization of the subset of the conflict axioms to the approximation of the formulae based on the determination.

8. The method of claim 5, further comprising refining the approximation of the formulae included in the inputted probabilistic model by adding the set of conflict axioms to the approximation of the formulae.

9. The method of claim 1, further comprising iteratively adding one or more of the axioms included in the inputted probabilistic model to subsequent approximated probabilistic models while MPE worlds returned from the relational learning engine respectively corresponding to the subsequent approximated probabilistic models violate at least one of the axioms of the inputted probabilistic model.

10. The method of claim 1, wherein the inputted probabilistic model is a Markov Logic Network (MLN).

11. The method of claim 1, wherein the approximated probabilistic model of the inputted probabilistic model includes domains from the inputted probabilistic model and the relations from the inputted probabilistic model.

12. The method of claim 1, further comprising detecting a query result pertaining to a query from the outputted MPE world, wherein the query corresponds to values of one or more of the relations included in the inputted probabilistic model desired to be estimated.

13. The method of claim 1, wherein the initial approximation of the formulae includes soft formulae included in the inputted probabilistic model.

14. A system that approximates an inputted probabilistic model for statistical relational learning, comprising:
an iterative approximation component that constructs an approximated probabilistic model from an inputted probabilistic model, wherein the approximated probabilistic model includes domains from the inputted probabilistic model, relations from the inputted probabilistic model, and an approximation of formulae from the inputted probabilistic model, and wherein the approximated probabilistic model is inputted to a relational learning engine;
a consistency check component that receives a most probable explanation (MPE) world from the relational learning engine based on the approximated probabilistic model and evaluates whether the MPE world from the relational learning engine satisfies axioms included in the inputted probabilistic model, wherein the consistency check component forms a set of conflict axioms identified as being violated by the MPE world when the inputted probabilistic is determined to include one or more axioms violated by the MPE world, and wherein the iterative approximation component constructs an updated, approximated probabilistic model based on the set of conflict axioms; and
an output component that outputs the MPE world when the consistency check component determines that the inputted probabilistic model lacks an axiom violated by the MPE world.

15. The system of claim 14, wherein the iterative approximation component further comprises a soft formulae selection component that selects soft formulae from the inputted probabilistic model for inclusion in the approximation of the formulae.

16. The system of claim 14, wherein the iterative approximation component further comprises an axiom selection component that omits axioms from the inputted probabilistic model from being included in an initial approximation of the formulae and iteratively adds a subset of the axioms from the inputted probabilistic model to subsequent approximations of the formulae.

17. The system of claim 14, wherein the MPE world is stored in a relational database, and wherein the consistency check component forms the set of conflict axioms violated by the MPE world using database querying.

18. The system of claim 14, further comprising a generalization component that generalizes the set of conflict axioms detected by the consistency check component, wherein the iterative approximation component constructs the updated, approximated probabilistic model based on the set of conflict axioms as generalized.

19. The system of claim 14, wherein the inputted probabilistic model is a Markov Logic Network (MLN).

20. A computer-readable storage medium including computer-executable instructions that, when executed by a processor, cause the processor to perform acts including:
forming an initial approximation of formulae included in an inputted probabilistic model, the initial approximation of the formulae included in the inputted probabilistic model omits axioms included in the inputted probabilistic model;
constructing an approximated probabilistic model of the inputted probabilistic model as a function of the approximation of the formulae;
inputting the approximated probabilistic model and evidence to a relational learning engine, wherein the evidence comprises existing valuations of a subset of relations included in the inputted probabilistic model;
receiving a most probable explanation (MPE) world from the relational learning engine, wherein the MPE world comprises valuations for the relations included in the inputted probabilistic model;
determining whether the axioms of the inputted probabilistic model are satisfied by the MPE world;
when at least one of the axioms of the inputted probabilistic model are violated by the MPE world:
forming a set of conflict axioms violated by the MPE world; and
refining the approximation of the formulae based on the set of conflict axioms, wherein the approximated probabilistic model inputted to the relational learning engine is updated based on the approximation of the formulae as refined; and
outputting the MPE world when the axioms of the inputted probabilistic model are satisfied by the MPE world.
